(19) United States
(12) Patent Application Publication
(10) Pub. No.: US 2005/0182714 A1
(43) Pub. Date: Aug. 18, 2005

(54) Wireless communications network for performing financial transactions

(76) Inventor: Pierre H. Nel, Fearie Glen 0043 (ZA)

Correspondence Address: Pierre H. Nel, P.O. Box 511, Faerie Glen 0043, ZA

(21) Appl. No.: 11/034,162

(22) Filed: Jan. 14, 2005

Related U.S. Application Data
(63) Continuation-in-part of application No. 09/739,786, filed on Dec. 20, 2000.
Application No. 09/739,786 is a continuation of application No. 09/048,216, filed on Mar. 26, 1998, now Pat. No. 6,363,364.

(30) Foreign Application Priority Data
Mar. 26, 1997 (ZA) 96/8078
Aug. 26, 1997 (ZA) 97/7635

(51) Int. Cl. G06F 17/60

(52) U.S. Cl. 705/39; 705/43; 705/42

(57) ABSTRACT

A system for and a method of performing interactive data exchange, for example, as part of a financial transaction, between a user base and a communications network, provides a financial account associated with the user as part of the network infrastructure. The system includes a request data input device. A communications network is connected to the device for transmitting the request data to the network. At the user base there is also provided a receiver for receiving response signals from the network and which signals include encoded response data. A signal decoder is provided at the user base to decode the response data. A display displays the response data interactively with the request data. The use of a financial (e.g., debit or credit) financial account as part of the network infrastructure allows financial transactions to be completed without involving any additional financial institution, credit card company or the like. In one advantageous implementation, the network may comprise a cellular telephone network.

### CROSS-REFERENCE TO RELATED APPLICATIONS

This is a continuation-in-part of application Ser. No. 09/739,786 filed Dec. 20, 2000, which is a continuation of application Ser. No. 09/048,216 filed Mar. 26, 1998, now U.S. Pat. No. 6,363,364. Each of these applications is incorporated herein by reference.

### FIELD

The technology herein relates to a method of and a system for conducting interactive data exchange functions between a user base, typically at home or at an office and a remote computer network.

### BACKGROUND AND SUMMARY

Known systems and methods for conducting home shopping and home banking transactions generally suffer from the disadvantage that they are either not fully interactive in real time and/or they do not provide a visual communication interface at the user base, such as the home or office. Accordingly, the technology herein provides a method and system which alleviates these disadvantages.

According to one aspect, a financial transaction system includes:
an interactive appliance operable by a user, the appliance allowing the user to remotely request goods or services from a service provider/financial institution;
a transmitter coupled to the appliance and to a shared cellular telephone communications network, the transmitter transmitting the request to the service provider/financial institution over the cellular telephone communications network;
a receiver at the user, the receiver receiving response signals including encoded response data from the network relating to said request; and
a signal decoder connected to the receiver, the signal decoder decoding the received encoded response data to provide secure communication of said data to said user via said network,
wherein said shared telephone communications network includes at least one financial account associated with said user, and wherein said user request authorizes said shared cellular telephone communications network to credit or debit said account in connection with said request.

The interactive data exchange function may be a data retrieval action or may form part of a financial transaction. The data exchange may relate to financial transactions including banking and/or shopping transactions. For example, financial transactions could include banking transactions such as balance requests, funds transfer transactions, electronic account payment transactions and purchase transactions with vendors and/or service providers connected to the network.

The receiver may include an antenna for receiving signals transmitted from the network via an earth orbiting satellite.

The signal decoder may form past of a decoder for decoding subscription television broadcasts and the display means may be in the form of a screen of a television set connected to the decoder.

The appliance may include a telephone instrument; and the transmitter may include a telephone network linking the instrument to the computer network.

In another exemplary illustrative non-limiting implementation, the decoder may be in the form of a decoder module forming part of a personal computer connected to the receiver means and the display means may be in the form of a screen of the personal computer.

The appliance may include a keyboard connected to the personal computer and the transmitter may include a modem connected to the personal computer and to a telephone network connectable to the computer network.

In yet another exemplary illustrative non-limiting implementation, the transmitter at the user base may be connected to an antenna to transmit the request data via an earth orbiting satellite to the computer network.

Also included within the technology described herein is an exemplary illustrative non-limiting method of financial transactions comprising:
transmitting request data over a communications network relating to a desired good or service;
receiving the request data and generating responsive data;
transmitting the responsive data over the same or different communications network in encoded form so it can be decoded only authorization of an intended recipient;
receiving the encoded data; decoding the received data;
displaying the data in real time and interactively with the request data transmitted; and
paying at least in part for said good or service by debiting an account associated with the intended recipient that is maintained at or by the communications network/service provider.

Further according to the exemplary method, at least one of the request data and the response signal is transmitted via a telephone network.

In other exemplary illustrative non-limiting implementations, at least part of the encoded response data may be transmitted by wireless transmission. More particularly, said at least part of the response data may be transmitted via an earth orbiting satellite to the decoder designated by the user.

In some exemplary illustrative non-limiting implementations, the request data may be transmitted from the user base to the network via a telephone network. Alternatively, the commands may be transmitted from the user base to the network via an earth orbiting satellite.

### BRIEF DESCRIPTION OF THE ACCOMPANYING DRAWINGS

These and other features and advantages will be better and more completely understood by referring to the following detailed description of exemplary illustrative non-limiting implementations in conjunction with the drawings, of which:

FIG. 1 is a block diagram of a first exemplary illustrative non-limiting implementation of a financial transaction system using satellite broadcast transmission and interactive voice response communications;

FIG. 2 is a block diagram of a second exemplary illustrative non-limiting implementation of a system using satellite broadcast transmission and Internet or other computer network communications;

FIG. 3 is a block diagram of a third exemplary illustrative non-limiting implementation of a system;

FIG. 4 is a block diagram of an exemplary system for performing financial data requests or transactions;

FIG. 5 is a block diagram of an exemplary illustrative non-limiting implementation of a system for performing a commercial transaction or function through a vendor network for accessing a product or service that may be held at a vendor database;

FIG. 6 is a block diagram of an exemplary illustrative non-limiting implementation of a system for performing service provider data requests or interactive information function;

FIG. 7 is a block diagram of an exemplary illustrative non-limiting implementation of a system for performing communication data requests or interactive communication functions; and

FIGS. 8 and 9 are block diagrams of additional exemplary illustrative non-limiting implementations employing financial accounts maintained by the communications network/service provider.

### DETAILED DESCRIPTION OF EXEMPLARY ILLUSTRATIVE NON-LIMITING IMPLEMENTATIONS

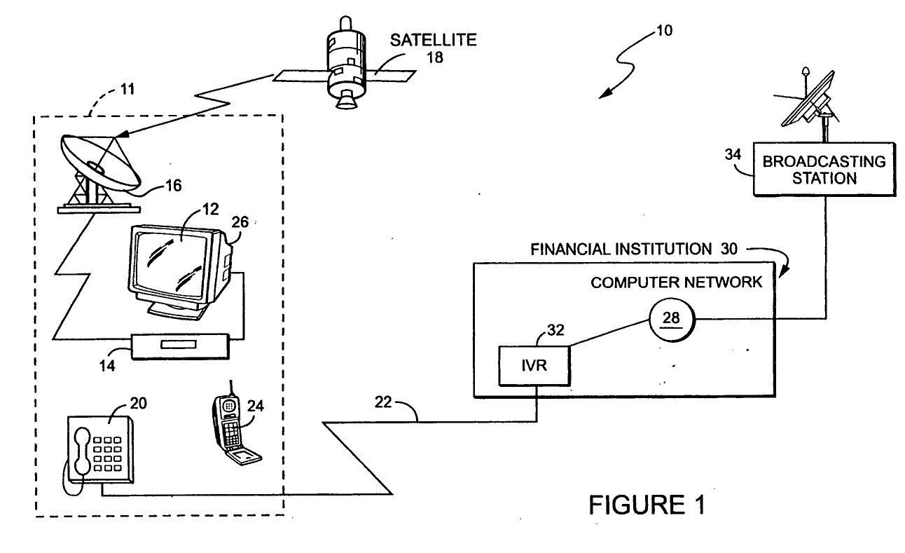

FIG. 1 shows a first illustrative non-limiting implementation of an exemplary interactive data exchange function system 10. This exemplary system 10 can be used to perform data exchange relating to financial transactions such as for example banking transactions including balance requests, funds transfer transactions, and electronic account payment transactions; and/or shopping or purchase transactions with vendors and/or service providers.

Exemplary system 10 includes any number of user bases or sites 11 (which may be dwellings, offices, or any other places where a user may be, for example) each equipped with a monitor 12 or other user appliance capable of presenting information to the user in visual and/or aural format. In the exemplary illustrative non-limiting implementation, the monitor 12 is connected to a broadcast signal decoder 14. The decoder 14 is connected to a dish or other antenna 16 for receiving signals from an earth orbiting satellite 18. Also provided at the user base 11 in this example illustrative non-limiting implementation is a multi-tone telephone instrument 20 connected to a wired telephone network 22. Furthermore, or alternatively, a cellular phone 24 having access to a cellular network may be provided at the user base 11.

In one example illustrative non-limiting implementation, the monitor 12 may form part of a television set 26, personal computer, cell phone, personal data appliance, or any other display type appliance. The decoder 14 may be a decoder for decoding subscription television broadcast signals. The antenna 16 is of the kind for receiving these broadcasts in this particular implementation.

Also connected to the telephone network 22 is a computer network 28 of a financial institution 30. The network 22 in this particular example includes an interactive voice response (IVR) front end 32 connected to the network. The network 28 is further connected to a broadcasting station 34 for transmitting encoded data signals to satellite 18, from where they are forwarded to dish antenna(es) 16.

In use, the user uses tones generated by the telephone instruments to transmit request data relating to messages and instructions via network 22 to computer network 28. The messages and instructions are invited and solicited by IVR front end 32. For example, the instruction from the user may be in the form of a request to the network 28 to provide the balance of an account of the user with the financial institution. The balance is then provided via the front end 32, telephone network 22 and instrument 20 or 24, where it is reproduced in audible form for the user to hear. At the same or different time, in addition or in lieu of the feedback provided via instruments 20, 22, encoded data relating to the balance is transmitted to broadcasting station 34. A signal including the data is transmitted to satellite 18. From satellite 18 the signal is forwarded downwardly, where it is received by antenna 16. The encoded data in the received signal is decoded by the decoder 14 and displayed on monitor 12 in real time and interactively in response to the aforementioned instruction.

FIG. 1 system preferably includes security mechanisms to ensure that only authorized users can gain access to information relating to certain accounts. Such measures could include account numbers and a personal identity number (PIN) transmitted from the instruments 20, 24 to the network 28 via network 22. Similarly, security measures are utilized to ensure that the requested data is only displayed on an authorized monitor 12. These measures may include an identification (ID) code number accompanying the data in the signal and which ID code enables only a designated decoder 14 to decode the encoded data in the signal. In this way, an essentially public broadcast transmission medium (i.e., satellite broadcast network 18) can be used to provide secure, private point-to-point one-way communication between financial institution 30 and user base 11.

The user may similarly instruct fund transfers between accounts to which he may have access at the financial institution 30 and payment of certain other accounts of third parties. Confirmation of the selected instruction, data requested and account balances are visually displayed in real time on the monitor 12, as hereinbefore described.

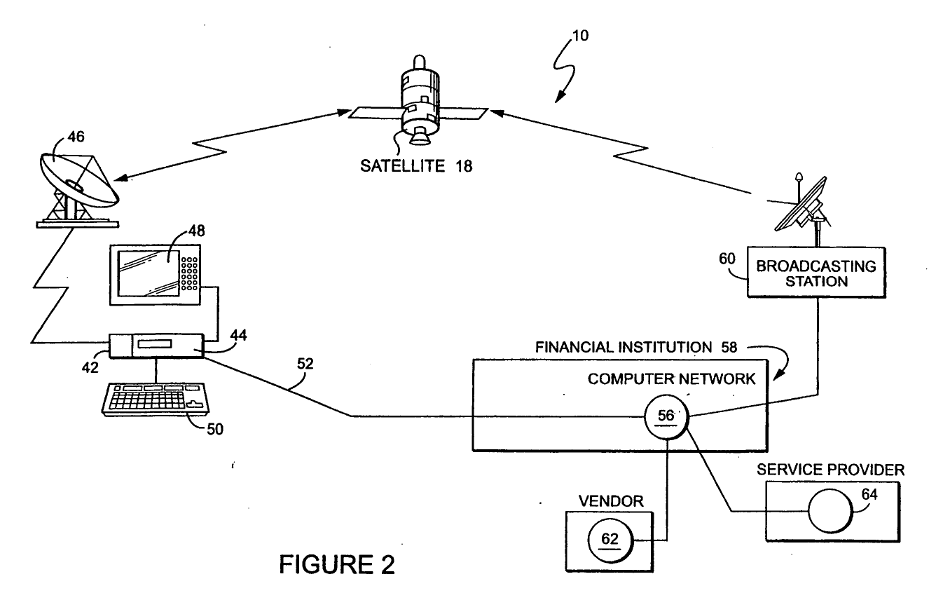

In a second exemplary illustrative non-limiting implementation of a financial transaction system 40 shown in FIG. 2, the decoder 14 shown in FIG. 1 may be implemented by a decoder card 42 (and/or software) provided within a personal computer (PC) 44. The decoder card 42 or other arrangement is connected to dish antenna 46. The monitor 48 is a conventional monitor of the personal computer 44 in this exemplary implementation. A keyboard 50 is connected to the computer 44, and the computer is connected via a modem (not shown) to telephone network 52, cable television network, the Internet, or other communications arrangement.

Telephone network 52 is connected to computer network 56 of financial institution 58. The computer network 56 is also connected to broadcasting station 60 as hereinbefore described. The computer networks 62 and 64 of a vendor and a service provider are also connected to computer network 56. This system also enables interactive communication between the user and the computer network 56 of the financial institution and the networks 62 and 64 of the vendor and the service provider. The user communicates with a selected one of networks 56, 62 and 64 via the keyboard 50, computer 44 and telephone network 52. However, encoded response data is carried by signals transmitted by broadcasting station 60 to satellite 18. The signals are received from the satellite by antenna 46, decoded by decoder 42 and displayed in visible form on monitor 48. Encoded response data may also be carried via telephone network 52 to decoder 42.

Apart from the aforementioned kind of financial transactions described hereinbefore, goods offered by the vendor may be viewed on monitor 48 by the user and ordered in real time via telephone network 52, network 56 and network 62. Payment for the goods may be made as hereinbefore described by a fund transfer transaction initiated by the user via keyboard 50. In a similar manner, services may be ordered and paid for.

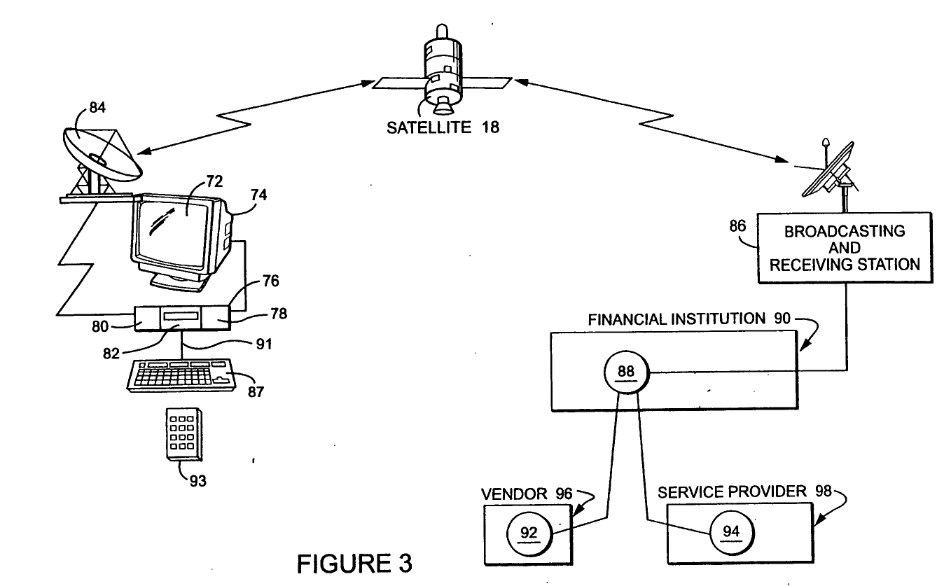

In a third exemplary illustrative non-limiting implementation 70 shown in FIG. 3, the monitor 72 forms part of a television set 74. The decoder 76 forms part of transceiver apparatus 78 including a receiver 80 and a transmitter 82. The transceiver is connected to antenna 84. The decoder is adapted to decode both subscription television broadcast signals and signals received from broadcasting and receiving stations 86. Instructions may be entered into a processor forming part of the transceiver apparatus via keyboard 87 connected by cable 91 to the apparatus or a portable, wireless transmitting unit 93 including a keypad.

The broadcasting and receiving station 86 is connected to a computer network 88 of a financial institution 90. The computer network 88 is also connected to computer networks 92 and 94 of a vendor 96 and a service provider 98.

In use, instruction and request data entered via keyboard 87 or device 93 are carried by signals generated and transmitted by the transmitter 82 forming part of the apparatus 78. The signals are transmitted via antenna 84 to satellite 18 and from satellite 18 to broadcasting and receiving station 86.

The user may request financial transactions as hereinbefore described. Encoded data is carried on signals transmitted to satellite 18 via broadcasting and receiving station 86. The transactions may include financial transactions involving accounts in the financial institution and other institutions connected to the institution 90. It may also include transactions with a selected one of a plurality of vendors connected to the network or a selected one of a plurality of service providers also connected to the network. The response data is caused to be displayed interactively and in real time on monitor 72.

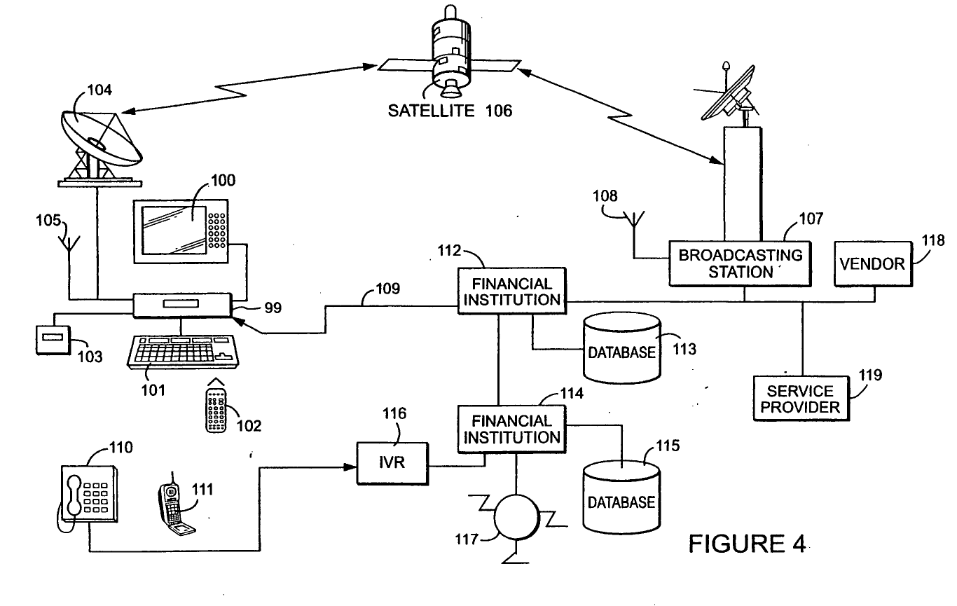

In FIG. 4, there is shown a further exemplary illustrative non-limiting implementation of a method or system for performing financial data requests or transactions. In this exemplary arrangement, the computer network has a first financial institution 112 and a second institution 114 with computer based client accounts held within a said first financial institution database 113 and a second financial institution database 115. The system allows users to access and manipulate at least one account held at said financial institution and transfer funds between accounts held by said first financial institution 112 and a second institution 114 by making a desired selection or input on at least one or more of the following input means; a keypad or keyboard 101, a remote control 102 or a telephone instrument such as a tone 110 or cellular phone 111 that is displayed on display means such as a television screen or computer monitor 100. Selections are communicated to a computer network of a financial institution through the decoder 99 via a telephone network 109 that may include the use of a modem or via RF signals by means of a receiver and transmitter 105 and 108 at user base and at the broadcaster or via bi-directional satellite 106 communication through a satellite dish at user base 104. Alternatively, a normal phone 110 or a cellular phone 111 or satellite phone may link to an IVR (Interactive voice response system) 116 which may serve as a front end to communicate user selections or inputs to the computer network of said financial institutions. From the computer network it may be communicated to the decoder via RF 105 and 108, telephone network 109 or satellite broadcast 106 from a broadcasting station 107. Also, linked to said computer network is a vendor 118 and a service provider 119. Furthermore a storage device reader and/or writer, for example, a smart card reader 103 internally to the decoder (not shown) or externally connected via a communications port such as a RS232 port may allow for payment or uploading and downloading of funds onto a smart card. Of course the first and second financial institution may be the same institution. The second account may be held by a vendor or service provider or third party to allow bill payments or for real time accounting and payment of users selected products of services. Further services can include account payments, funds transfers, managing debit orders, account viewing, account management, etc. Also, product based financial functions such as shares, mutual funds, futures and the like may be done via the said system. Existing systems or networks or other infrastructures 117, for example, ATM (Automated Teller Machines), CAT (Client Activated Terminals), SST (Self Service Terminals) networks may be used to process and execute user request or inputs. The smart card may in conjunction with the PIN be used for user and account identification and the encryption and decryption communicated from the financial institution to the smart card and vice versa. Printing means may be linked to the decoder to allow printing of statements, transactions and accounts via a communication port such as the RS232 port.

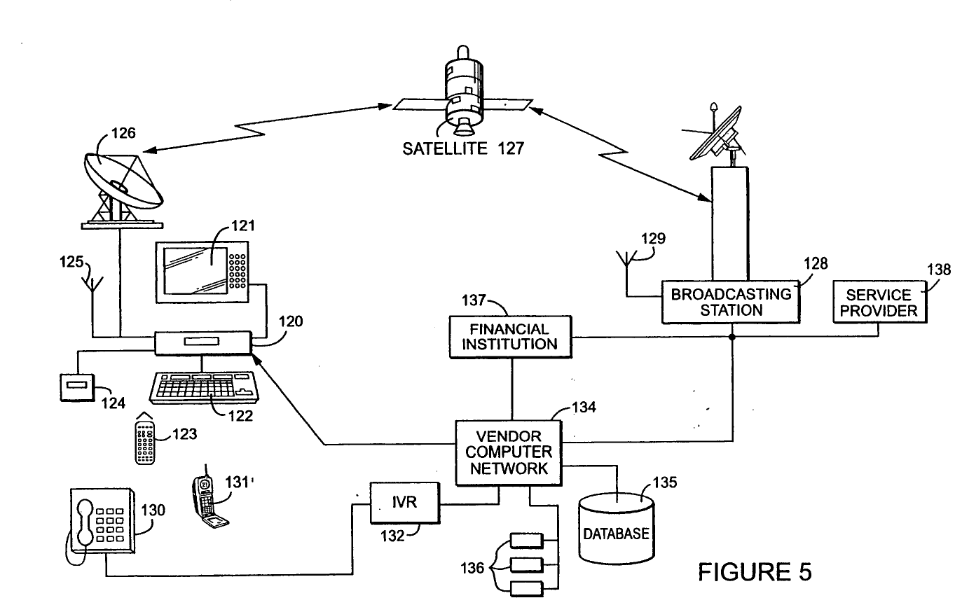

FIG. 5 relates to an exemplary method and system for performing a commercial transaction or function through a vendor network for accessing a product or service that may be held at a vendor database

The computer network has a vendor computer network 134 with at least one database 135 with products and services. The system allows users to access and manipulate at least one vendor product or service 136 held at said vendor network by making a desired selection or input on at least one or more of the following input means; a keypad or keyboard 122. A remote control 123 or a telephone instrument such as a tone 130 or cellular phone 131 that is displayed on display means such as a television screen or computer monitor 121. Selections are communicated to a computer network of a vendor through the decoder 120 via a telephone network that may include the use of a modem or via RF signals by means of a receiver and transmitter 125 and 129 at user base and at the broadcaster or via bi-directional satellite 127 communication through a satellite dish at user base 126. Alternatively, a normal phone 130 or a cellular phone 131 or satellite phone may link to an IVR (interactive voice response system) 132 which may serve as a front-end to communicate user selections or inputs to the computer network of said vendor computer network 134. From the vendor computer network it may be communicated to the decoder via RF 129 and 125, telephone network or satellite broadcast 127 from a broadcasting station 128. Also, linked to said computer network may include a financial institution 137, for example, a bank and a service provider 138. Furthermore a storage device reader and/or writer, for example, a smart card reader 124 internally to the decoder (not shown) or externally connected via a communications port such as a RS232 port may allow for payment or uploading and downloading of funds onto a smart card. The vendor and the financial institution may be the same institution. The second account may be held by a vendor or service provider or third party at the financial institution to allow bill payments or for real time accounting and payment of users selected products of services. The smart card may in conjunction with the PIN be used for user identification and the encryption and decryption communicated from the financial institution or vendor to the smart card and vice versa. Printing means may be linked to the decoder to allow printing of statements, transactions and accounts via a communication port such as the RS232 port. Products may include access to a broadcast channel and a broadcast item, for example, a movie or documentary program vendible from the broadcasting station. Other products may include financial products such as shares, mutual funds, futures, insurance; commercial insurance; commercial products such as movie and performance access or tickets, travel related products, mail order catalogues products and gaming products, for example, betting on race horse and gambling, for example, casino games. Also, software and information such as news and stock market updates may be vended to the user. Payment may be made through the transfer of funds between said financial institutions by transferring funds between user and vendor accounts. Alternatively, payment may be done via smart card through the smart card reader/writer at user base to allow transfer of funds and the downloading and uploading of funds to said smart card to the value of the transaction relating to said product or service.

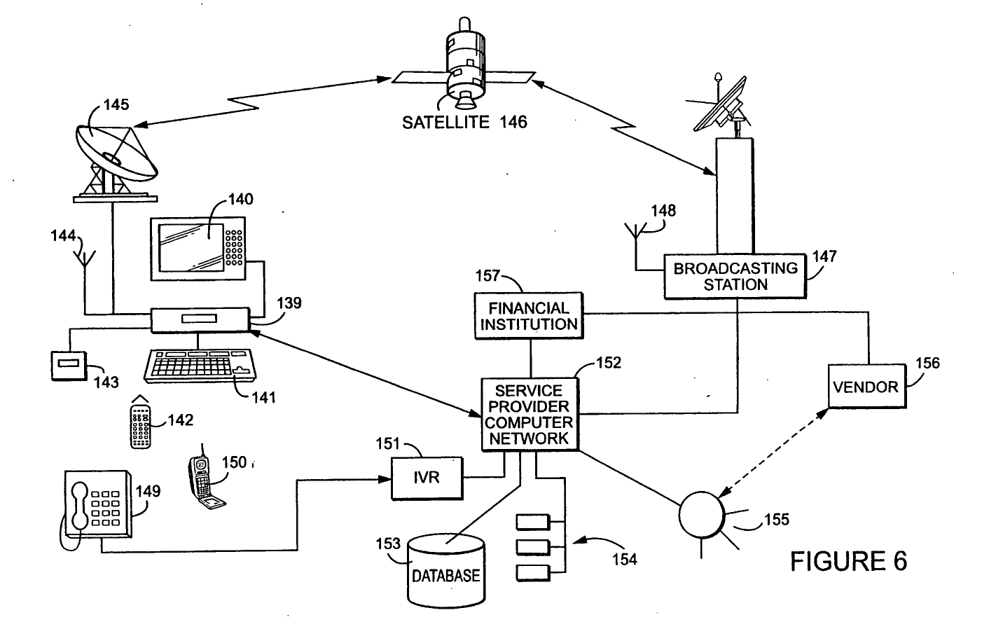

FIG. 6 relates to an exemplary method and system for performing a service provider data requests or interactive information function.

This exemplary arrangement provides a service provider computer network 152 with at least one database 153 with information and communication products and services 154 such as Internet access an E-mail. The system allows users to access and manipulate at least one information product or service 154 held at said service provider network 152 by making a desired selection or input on at least one or more of the following input means; a keypad or keyboard 141, a remote control 142 or a telephone instrument such as a tone 149 or cellular phone 150 that is displayed on display means such as a television screen or computer monitor 140. Selections are communicated to a computer network of a service provider through the decoder 139 via a telephone network that may include the use of a modem or via RF signals by means of a receiver and transmitter 144 and 148 at user base and at the broadcaster or via bi-directional satellite 146 communication through a satellite dish at user base 145. Alternatively, a normal phone 149 or a cellular phone 150 or satellite phone may link to an IVR (Interactive voice response system) 151 which may serve as a front-end to communicate user selections or inputs to the computer network of said service provider computer network 152. From the service provider computer network it may be communicated to the decoder via RF 149 and 144, telephone network or satellite broadcast 146 from a broadcasting station 147. Also, linked to said computer network may include a financial institution 157, for example, a bank and a vendor 156. Furthermore a storage device reader and/or writer, for example, a smart card reader 143 internally to the decoder (not shown) or externally connected via a communications port such as a R5232 port may allow for payment or uploading and downloading of funds onto a smart card. Of course the vendor and the financial institution and the service provider may be the same institution. An account may be held by a vendor or service provider or third party at the financial institution to allow bill payments or for real time accounting and payment of users selected service provider products of services. The smart card may in conjunction with the PIN be used for user identification and the encryption and decryption communicated from the financial institution or service provider to the smart card and vice versa. Printing means may be linked to the decoder to allow printing of statements, transactions and accounts via a communication port such as the RS232 port. Service provider services and products may include Internet 155 related services such as access to the World Wide Web, News groups and the sending and receiving of E-mail of a user that may be stored on a database at said service provider network. The Internet 155 may link vendors and financial institutions to the service provider network.

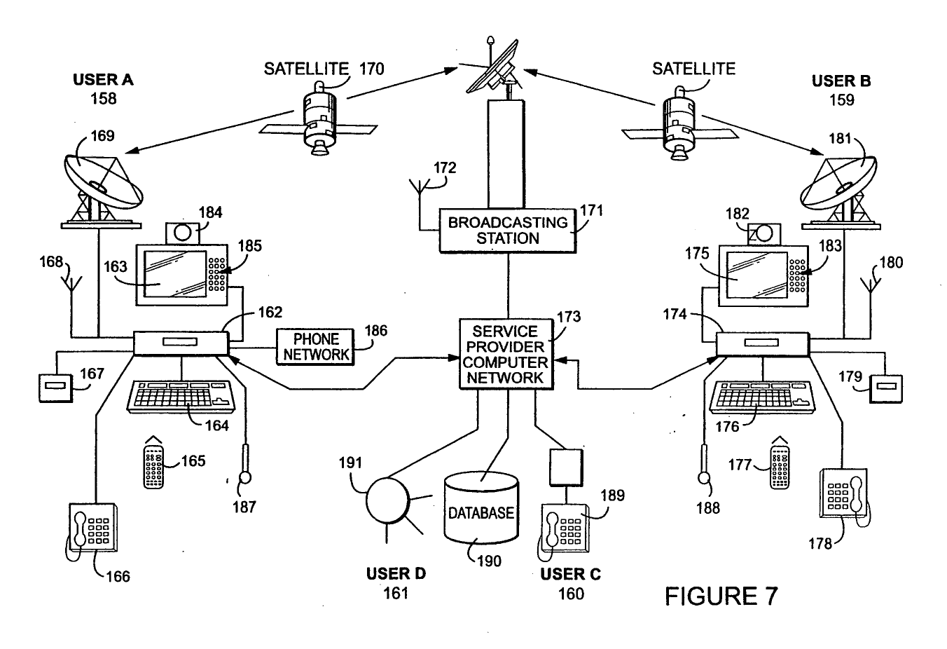

FIG. 7 relates to an exemplary method and system for performing communication data requests or interactive communication functions.

This exemplary arrangement has a service provider computer network 173 with at least one database 190 providing information and communication products and services such as on-line education and conferencing. The system allows users to make a telephone call or teleconferencing between similar decoder users 158 and 159 with decoders 162 and 174 or Internet telephone and teleconferencing users 1 61 or normal telephone network users 160 and communicate at least one communication product or service held at said service provider network 173 by making a desired selection or input on at least one or more of the following input means; a keypad or keyboard 164, 176, a remote control 165, 177 or a telephone instrument such as a phone 166 and 178. The telephones link to the decoders to allow the decoders 162 and 174 to act as interface or mechanism for telephone communication. With teleconferencing an image capturing device 184 and 182 may allow visual data or information to be communicated to users over the network. A microphone 187 and 188 may serve as voice recording interface that allows audio to be communicated to said users and the images is displayed on display means such as a television screen or computer monitor 163 and 175 and audio is reproduced via speakers 183 and 185 or linked speakers to a PC 186. Selections and voice and images are communicated to a computer network of a service provider through the decoder 162 and 174 via a telephone network that may include the use of a modem or via RF signals by means of a receivers and transmitters 168 and 172 and 180 at user base and at the broadcaster 171 or via bi-directional satellite 170 communication through a satellite dish at user base 169 and 181. From the service provider computer network 173 or broadcasting station 171 it may be communicated to the decoders via RF and telephone network or satellite broadcast 170 from a broadcasting station 171. Furthermore a storage device reader and/or writer, for example, a smart card reader 167 and 179 internally to the decoder (not shown) or externally connected via a communications port such as a RS232 port may allow for payment or uploading and downloading of funds onto a smart card. Of course the vendor and the financial institution and the service provider may be the same institution. An account may be held by a vendor or service provider or third party at the financial institution to allow bill payments or for real time accounting and payment of users selected communication service provider of products of services. The smart card may in conjunction with the PIN be used for user identification and the encryption and decryption communicated from the financial institution or service provider to the smart card and vice versa to allow for payment. Recording means may be linked to the decoder to allow for recording of communication services via a communication port such as the RS232 port. Service provider services and products may include Internet 191 related services such as Internet phoning and teleconferencing and normal phoning from decoder to normal phones on a telephone network 189 and vice versa. The user smart card may serve as ID for directing and controlling communication services.

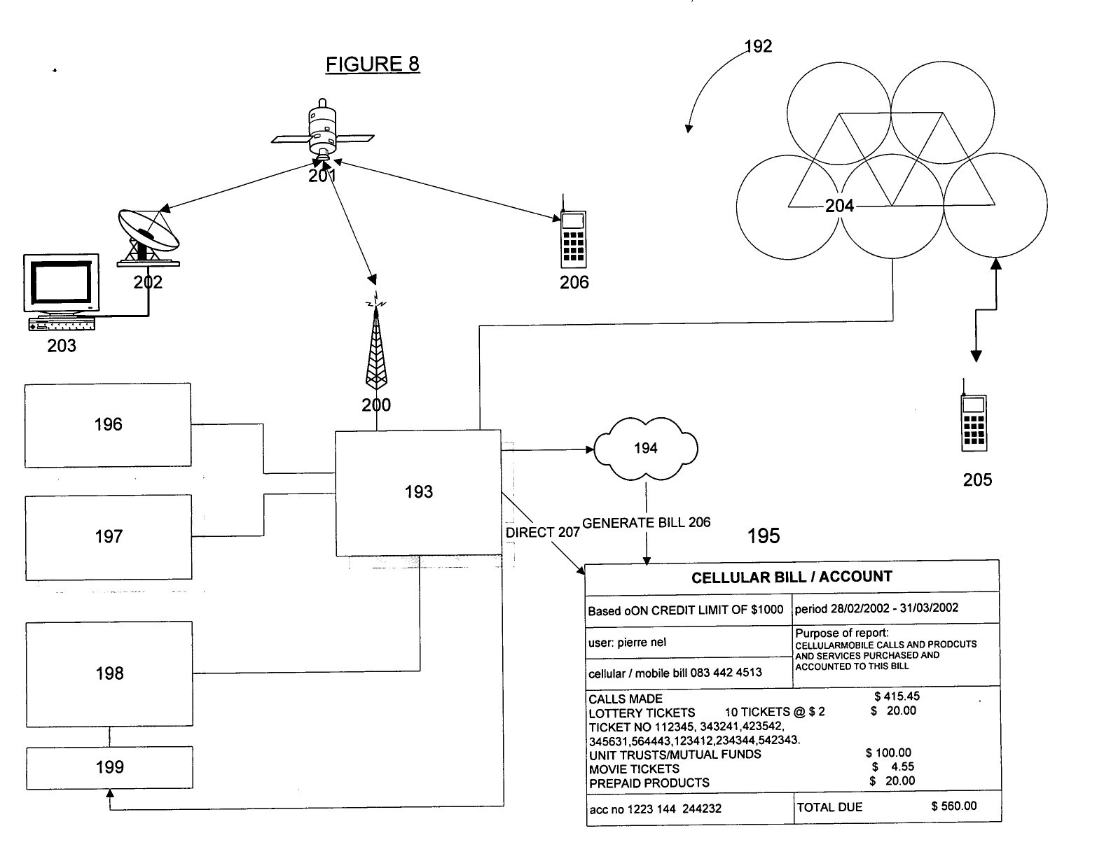

FIG. 8 shows a further exemplary illustrative non-limiting implementation of a financial transaction system 192. In this exemplary implementation, a user may have or maintain one or more financial account(s) 195 held at and/or administered by the telephone operator or network operator 193 and/or at a service provider 194. Thus, in this exemplary implementation, instead of having to open an account at the Financial Institution such as a bank to transfer and use funds from, the user can access an account administered at the cellular/mobile/telephone network operator. Funds which may be used to purchase products and/or services from vendors, pay accounts, perform funds transfers or to pay service providers is held in-house by the network operator or service provider. In this arrangement, the funds are closer to the communications infrastructure that is enabling performance of the transaction—which should save in transaction costs since the user bank account is not used as origin point for transactions. In use, a user may manipulate the funds or credit in his/her one or more accounts 195 at the service provider 194 or network operator 194 to do transactions with any one or more of: a vendor 196, a service provider 197 and a bank 198. Also funds may be transferred from the user account 195 to a bank account 199 for example. In use, a user may for example use the subscription decoder 203 via a satellite dish 202 or other broadcast infrastructure (e.g., the Internet) to request a data exchange function for with any one or more of: a financial institution 198, a service provider 197, and a vendor 196 relating to a financial transaction such as a payment or funds transfer. From the satellite dish, it may be communicated to a satellite 201 and to a communication tower or station 200 which in turn is connected or in communication with the network operator 193 and/or service provider 194. A telephone network (not shown) may also or alternatively be used to communicate a data exchange function and have the response data received via the satellite 201 to the decoder via the satellite dish. In another exemplary illustrative non-limiting implementation, a satellite phone 207 may be used in conjunction with a communication satellite 208 to perform data exchange functions as discussed. In yet another exemplary illustrative non-limiting implementation, the user may use a cellular or mobile phone 205 in conjunction with a cellular/mobile network 204 to request data exchange functions from a network operator, telecommunications network 193 and/or a service provider. The data exchange functions may include examples as mentioned and discussed in previous Figures and descriptions.

The account 194 at the service provider 194 or the network may be a credit or debit account. In the case of a credit account, the user may have a credit limit which may be used to describe a limit of funds that can be used and then be settled monthly or otherwise arranged. In use, a user may deposit a salary or other payment or check in the account 195 much the same as it is currently deposited into a bank account. Now the network operator or service provider becomes a bank or acts in the capacity or in functioning as a bank or other financial institution. Since the funds or credit facility is now held at the source, costs are saved in obtaining and authorizing the payment etc. not from a bank which saves the user additional transaction charges.

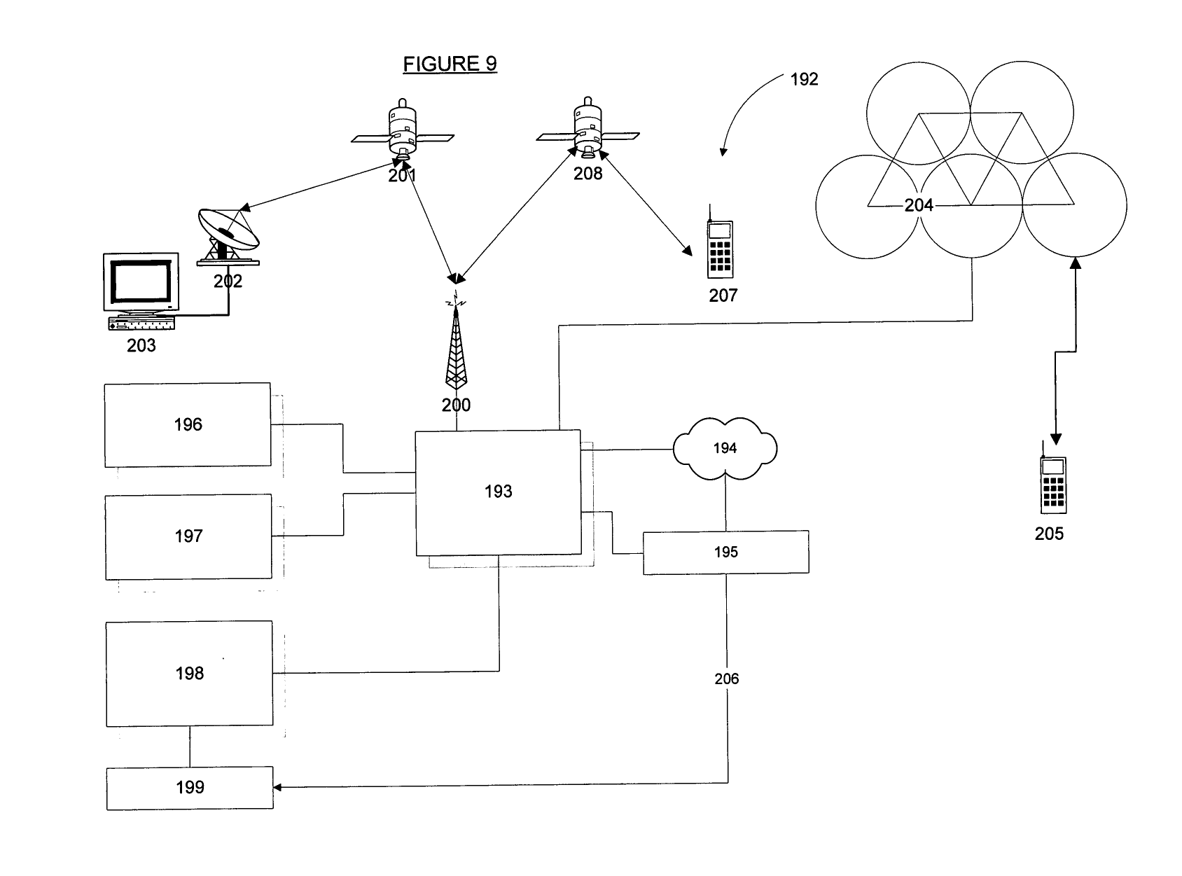

FIG. 9 shows a further exemplary illustrative non-limiting implementation of a financial transaction system 192 in which a user may have one or more Cellular/Mobile bills 195 at the telephone operator or network operator 193 and/or at a service provider 194. The bill(s) may be generated 206 via a service provider 195 or directly 207 via the network operator 193. In use, a transaction request function may provide or include products and/or services such as lottery tickets, unit trust or mutual fund investments, movie tickets and prepaid products which are added to the users cellular/mobile account or bill 195. In use, a user may for example use the subscription decoder 203 via a satellite dish 202 (or any of the other arrangements discussed above) to request a data exchange function for with any one or more of: a financial institution 198, a service provider 197, and a vendor 196 relating to a financial transaction such as a payment or funds transfer to a bank account 199. From the satellite dish or other data transmitter, the information may be communicated to a satellite 201 and to a communication tower or station 200 which in turn is connected or in communication with the network operator 193 and/or service provider 194. A telephone network (not shown) may also be used to communicate a data exchange function and have the response data received via the satellite 201 to the decoder via the satellite dish. In another exemplary implementation, a satellite phone 209 may be used in conjunction with a communication satellite 208 to perform data exchange functions as discussed. In yet another exemplary illustrative non-limiting implementation, the user may use a cellular or mobile phone 205 in conjunction with a cellular/mobile network 204 to request data exchange functions from a network operator, telecommunications network 193 and/or a service provider.

The data exchange functions may include examples as mentioned and discussed in previous Figures and descriptions. It is envisaged that the account at the service provider or the network may be used in the same manner as a credit or debit account. In the case of a credit account, the user may have a credit limit which may be used to describe a limit of funds that can be used and then be settled monthly or otherwise arranged. Presently, users typically only have mobile communication charges on their bills. In the US, it is known to bill certain types of services on a telephone bill using “900” numbers. In the exemplary arrangement shown in FIG. 9, products and service may be billed to their cellular account and then settled. The use of the cellular bill or account may become like that of a credit account with appropriate credit rating which limits the amount of funds to be used in obtaining and paying for products and services. Should the cellular bill or account be used as a debit facility, a user may deposit a predetermined amount into the account which is held in lieu of payment of products and services. The use of prepaid accounts or prepaid facilities is well known. In the case of a user having a prepaid phone or prepaid account the costs of products and services may be deducted from their prepaid credit or prepaid balance help in relation to their user ID and/or phone ID.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

1. A financial transaction system including:
an interactive appliance operable by a user, the appliance allowing the user to remotely request goods or services from a service provider/financial institution;
a transmitter coupled to the appliance and to a shared cellular telephone communications network infrastructure, the transmitter transmitting the request to the service provider over the cellular telephone communications network;
a receiver at the user, the receiver receiving response signals including encoded response data from the network relating to said request; and
a signal decoder connected to the receiver, the signal decoder decoding the received encoded response data to provide secure communication of said data to said user via said network,
wherein said shared telephone communications network infrastructure maintains at least one financial account associated with said user, and wherein said user request authorizes said shared cellular telephone communications network to credit or debit said account in connection with said request.

2. A system as claimed in claim 1 wherein the receiver includes an antenna for receiving signals transmitted from the network via an earth orbiting satellite.

3. A system as claimed in claim 1 wherein the appliance includes a cellular telephone instrument; and wherein the transmitter includes a wireless radio link linking the instrument to the network.

4. A system as claimed in claim 1 wherein the appliance includes a mobile telephone instrument; and wherein the transmitter includes a wireless radio link linking the instrument to the network.

5. A system as claimed in claim 1 wherein the appliance includes a PDA (Personal Desktop Assistant) instrument; and wherein the transmitter includes a wireless radio link linking the instrument to the network.

6. A system as claimed in claim 1 wherein the decoder comprises a decoder module forming part of a personal computing device connected to the receiver, and wherein the appliance includes a screen of the personal computing device

7. A system as claimed in claim 1 wherein the transmitter is connected to an antenna to transmit the request data via an earth orbiting satellite to the network.

8. A method of financial transactions comprising:
transmitting request data over a communications network relating to a desired good or service;
receiving the request data and generating responsive data;
transmitting the responsive data over the same or different communications network in encoded form so it can be decoded only authorization of an intended recipient;
receiving the encoded data;
decoding the received data;
displaying the data in real time and interactively with the request data transmitted; and
paying at least in part for said good or service by debiting an account associated with the intended recipient that is maintained at or by the communications network.

9. A method as claimed an claim 8 wherein at least one of the request data and the response data is transmitted via a cellular telephone network.

10. A method as claimed in claim 8 wherein at least part of the encoded response data is transmitted by wireless transmission.

11. A method as claimed in claim 10 wherein said at least part of the response data is transmitted via an earth orbiting satellite.

12. A method as claimed in claim 11 wherein the request data is transmitted via an earth orbiting satellite.

13. The method of claim 8 wherein said account comprises a debit account associated with said recipient.

14. The method of claim 8 wherein said account comprises a credit account associated with said recipient.

15. The method of claim 14 wherein said account has a credit limit associated therewith.

16. The method of claim 8 further including sending said recipient a cellular telephone bill including financial transactions involving said account.

17. The method of claim 8 further including having the recipient deposit initial funds with said network to fund said account.

18. The method of claim 8 further including communicating said encoded data to plural cellular telephones, and authorizing only predetermined cellular telephones to decode said data.

19. The method of claim 8 further including displaying said decoded responsive data on a cellular telephone display

20. The method of claim 8 further including displaying said decoded responsive data on a personal computing device display

21. The method of claim 8 further including displaying said decoded responsive data on the display of a wireless personal data assistant (PDA).

22. The method of claim 8 further including communicating at least some of said data over the Internet or other computer network.
